(19) United States
(12) Patent Application Publication
(10) Pub. No.: US 2024/0065342 A1
(43) Pub. Date: Feb. 29, 2024

(54) Purging the Inside of a Device with Nitrogen

(71) Applicant: JT International SA, Geneva (CH)

(72) Inventors: Kyle Adair, Lisburn (GB); Olayiwola Olamiposi Popoola, Walton-on-Thames (GB); Peter Loveday, Epsom Surrey (GB)

(73) Assignee: JT International SA, Geneva (CH)

(21) Appl. No.: 18/272,239

(22) PCT Filed: Jan. 26, 2022
(86) PCT No.: PCT/EP2022/051746

§ 371 Date: Jul. 13, 2023

(30) Foreign Application Priority Data
Jan. 26, 2021 (EP) 21153559.6

(51) Int. Cl. A24F 40/70; A24F 40/485; B08B 5/02; B08B 17/02

(52) U.S. Cl. CPC A24F 40/70; A24F 40/485; B08B 5/02; B08B 17/02

(57) ABSTRACT

A method for excluding humidity and/or oxygen and/or other fluids from an inner cavity of an electronic smoking device surrounded by an outer hull, the cavity being fluid tight to its environment by at least one seal and having at least one input and at least one output having at least one hole through the hull and into the cavity through which fluids can pass and which can be closed with a closure, the method includes first filling an inert gas through the input into the cavity, displacing fluids inside the cavity by flushing them out with the inert gas through the output and afterwards the input and the output are permanently closed with its closure.

The present invention relates to a method for manufacturing electronic smoking devices. Electronic smoking devices which provide an inhalable vapour are known from the state of the art. Such electronic smoking devices are usually manufactured in large quantities in fabrics either by fully automated stations or by hand from assembly workers at conveyors. However, one of the last steps of assembling an electronic smoking device is to put all previously prepared parts together and seal the electronic smoking device at least partially. This last assembling step is usually executed in a normal atmosphere which, on earth, contains air and thereby nitrogen, oxygen, water and other components. Due to the method of the last assembling step, all components which are present in the atmosphere are also enclosed within at last one part of the electronic smoking device.

While the inclusion of nitrogen inside an electronic smoking device is normally not a problem, water and oxygen can condensate in a sealed cavity inside the device and mildew formation can occur. Water and oxygen in contact with unprotected electric parts can also lead to damage of the electronic components inside the device due to corrosion and/or short-circuits.

In the document U.S. Ser. No. 10/285,449B2 a replaceable liquid cartridge for housing a vaporizable substance is disclosed wherein this cartridge is purged with Argon to prevent the liquid inside the cartridge from oxidation. However, this document only concerns about protecting liquid inside a not permanently sealed cartridge and further expensive argon gas is used as an inert gas.

It is therefore the object of the invention to prevent the risk of mildew forming and short-circuits due to water and humidity and also to prevent potential corrosion due to oxygen inside an electronic smoking device by excluding humidity, oxygen and other fluids from the inside of the device. This is achieved by the method of claim 1. Preferred method steps of the invention are object of the subclaims.

The afore mentioned problems are solved by a method for excluding humidity and/or oxygen and/or other fluids from an inner cavity of an electronic smoking device surrounded by an outer hull, the cavity being fluid tight to its environment by at least one seal and having at least one input and at least one output comprising at least one hole through the hull and into the cavity through which fluids can pass and which can be closed with a closure. Due to the hole in the hull fluids inside the electronic smoking device can be replaced by an inert gas which does not include humidity and/or oxygen.

According to the invention first an inert gas is filled through the input into the cavity, displacing fluids inside the cavity by flushing them out with the inert gas through the output and afterwards the input and the output are permanently closed with their closure.

This permanent closing of a cavity after filling it with an inert gas leads to an atmosphere inside the cavity which consists mainly of inert gas and by that protects parts arranged inside the cavity from reacting with reactive components in the air.

Preferably the permanently closure of the cavity is not opened during the usage of the device. It is conceivable, that the permanent closure of the cavity is not opened until the device is not used anymore and thus dumped and/or recycled. The permanent closure thereby seals the inert gas inside the cavity over the complete lifespan of the electronic smoking device.

According to another embodiment, the input and/or the output are valves, preferably one-way valves, or are a hole in the hull for a later attached hardware, wherein the hardware closes the hole when attached to it and thereby acts as its closure, wherein the hardware is preferably a USB-port and/or a display.

It is conceivable that the input and output are valves, preferably one way valves. The gas is filled into the cigarette through the inlet valve with a suitable device and exhausts from the outlet valve. A suitable device for inserting the inert gas through the inlet valve might be a nozzle and/or a different object which is fluid tight attachable to the input valve. Preferably at least one valve, preferably the output valve, is manually closable and/or has a specific resistance which allows to keep an overpressure inside the device. Accordingly, when filling the electronic smoking device, both valves would first be open to flush the device. After a desired purity of inert gas within the device is achieved, at least one valve, preferably the outlet valve, is closed. If the outlet valve is closed first, inert gas can still be inserted via the input valve to build up a desired pressure inside the device. Overpressure inside the cavity is desirable to prevent air from entering the cavity in case of a small leakage. In addition, due to different coefficients of thermal expansion of the outer hull and the inert gas inside the cavity, a varying internal pressure can occur in the electronic smoking device, which may lead to a negative pressure. A negative pressure in the cavity would be disadvantageous, as it could prefer air to enter the electronic smoking device. After achieving a desired pressure, also the input valve is closed. Preferably closing the input and output valve means to permanently seal them fluid tight.

It is also conceivable that the input and/or output is a hole in the hull for a later permanently attached hardware, wherein the hardware closes the hole when attached to the device and thereby acts as its closure, wherein the hardware is preferably a USB-port and/or a display. It is conceivable that the corresponding hardware can also be a receptacle for a mouthpiece, a button and/or a different module which is later on permanently attached to the electronic smoking device.

It is also conceivable that the input is either a valve or a hole according to one of the two embodiments described above and the output is realized according to the respective other embodiment.

It is conceivable that the closures are sealed with a special sealing material. This material could be a rubber or silicon based material, but also glue or other solutions for a permanent sealing are conceivable. Thermal joining or a fluid tight fitting are also conceivable. Thermal joining or a fluid tight fitting can be used without further additives, wherein a glue and/or silicon based sealing would be the more reliable seals in terms of being fluid tight.

In another embodiment, before filling the cavity with the inert gas and closing the in- and output, a vacuum is applied to the cavity. Preferably this procedure is used for embodiments of the electronic smoking device where the input and output are arranged in the same hole, because a one hole arrangement would prevent the possibility of flushing the inert gas through the device. It is conceivable that also the filling of a cavity with overpressure and afterwards releasing the pressure is possible to remove fluids from inside the cavity.

In another embodiment, the procedure of applying vacuum to the cavity and then filling it with an inert gas is repeated at least once before the in- and output is closed. Preferably this procedure is especially used for embodiments of electronic smoking articles where one common hole is used as input and output. With each repetition the purity of inert gas in the cavity would rise.

It is conceivable that also the filling of the cavity with inert gas and a subsequent releasing of the pressure is repeated to obtain a desired degree of purity. It is also conceivable that the amount of applied vacuum and/or overpressure determines how often the vacuum and/or overpressure have to be applied. For example, when the pressure in the cavity is decreased to 0.5 bar internal pressure, more oxygen and water remain inside the cavity than if the pressure after evacuation was only 0.2 bar. The same applies in reverse proportion to applying overpressure inside the cavity.

In a preferred embodiment, the inert gas is nitrogen and/or a noble gas. It is conceivable that every non-reactive gas can be used as an inert gas for this application. Due to the low temperature ranges in which the device is used compared to welding, for example, where inert gases are also used, it is not necessary to use expensive noble gases. It is conceivable that the temperature range in which the cigarette is used might range from −50° C. to 80° C.

In a preferred embodiment, the filling pressure of the inert gas into the cavity is 2 psi. Preferably the filling pressure is calculated in such way that the inner pressure of the cavity never becomes negative. Very preferably the pressure inside the electronic smoking device does not become negative in the temperature range from −50° C. to 80° C. This would prevent a negative pressure inside the cavity due to temperature related pressure changes, which in turn occur due to the fact that the material of the outer hull of the electronic device behaves differently to the enclosed gas when temperature changes happen. It would also prevent the increased possibility of air entering through negative pressure in the device which in turn would lead to humidity and oxygen intake into the device.

It is conceivable that the pressure inside the cavity varies with temperature changes due to the material of the outer hull preferably being a solid Material and thereby the cavity preferably comprising a constant volume. The solid material of the outer hull, which surrounds the cavity, is preferably not bendable. Thereby the material of the outer hull remains in its form upon pressure changes inside the cavity, while pressure changes in the cavity might occur upon temperature changes and thereby expansion or contraction of the gas inside the cavity. Preferably the volume of the cavity remains constant while using of the electronic smoking device.

It is conceivable that the volume of the inner cavity changes slightly upon temperature related expansion or contraction from the outer hull material.

According to the invention an electronic smoking device comprises an inner cavity surrounded by an outer hull, the cavity being fluid tight to its environment by at least one seal and having at least one input and one output comprising of at least one hole through the hull and into the cavity through which fluids can pass and which can be closed with a respective closure. Preferably the input and/or output are designed to allow a fluid to pass through them from outside the device into the cavity and vice versa.

According to the invention the inner cavity of the electronic smoking article comprises an inert gas, wherein the inert gas prevents the risk of corrosion, fogging, moisture building and high pressure building inside the electronic smoking device. Preferably the inert gas has a low coefficient of thermal expansion, which would lead to relatively small pressure fluctuations inside the cavity of the electronic smoking article.

Preferably the inert gas inside the cavity exclusively extends of an inert gas. It is also conceivable that the inert gas inside the cavity is a mixture of different inert and/or noble gases.

In a preferred embodiment the input and output are located at positions in the hull, which comprise a respective maximum distance to each other. It is conceivable that the best arrangement of the input and output is such that there is as much space as possible between them, so that as much fluid as possible is carried away from the inside of the device when flushing the device with inert gas from the input to the output. It is conceivable that if the input and output are not arranged at a maximum respective distance to each other, the flushing might last longer to achieve a desired purity of inert gas inside the electronic smoking device.

In another embodiment the closure of the in- and/or output is a valve, USB plug and/or other component, which is inserted in the hull. It is conceivable that at least one small component of a respective closure can also act as an input and/or output, e.g. a small part of the USB plug itself. This would eliminate the need to attach extra valves, which in turn could lead to leaks.

In a preferred embodiment the seal for the input and output is fluid tight. Preferably the seal is also fluid tight when pressure is applied. Very preferably the sealing is fluid tight at a pressure of at least 2 psi. It is conceivable that the sealing is also fluid tight when a negative pressure is applied, which is important if there should be negative pressure inside the device which may be caused by temperature changes.

It is conceivable that the final sealing of the cavity can be done by applying an overpressure inside the cavity through at least one hole of a component which is inserted in the outer hull of the device an then letting the device seal itself by the inside pressure pressing the at least one component from the inside of the electronic smoking device against the outer hull which thereby seals the hole in the outer hull. Preferably the contact area between the component and the outer hull, very preferably the contact area on the component is previously provided with adhesive in order to prevent the seal from re-opening due to external forces.

In another preferred embodiment the cavity encloses electronic parts. Preferably the cavity encloses all electronic parts which are permanently attached to the electronic smoking device. Very preferably all electronic parts that are not otherwise protected from corrosion and/or short circuits are arranged inside the cavity. Arranging all electronic and/or metallic parts which could be affected by corrosion inside the cavity would eliminate the need for further isolation at the electronic smoking article.

In a preferred embodiment the pressure inside the cavity is set to a minimum value of 2 psi overpressure. Preferably an overpressure in the cavity can compensate temperature related pressure changes. This is important considering that the electronic smoking device can also be used in environments with different temperatures and thus the inner pressure of the device can change. It is understood that it is necessary to avoid a negative pressure inside the electronic smoking device, because this might relate to air intake inside the cavity which in turn leads to humidity and oxygen intake into the device.

Preferably the required internal pressure is calculated over the expected temperature range in which the device is expected to be used and the coefficient of expansion of the device and the inert gas.

In a preferred embodiment the input and output are arranged in the same hole in the hull. It is conceivable that a configuration that uses only one hole as inlet and outlet at the same time is advantageous in so far as it comprises less sealing area and therefore the chance of a leakage is reduced. It is conceivable that a hollow object, preferably longitudinal shaped, is inserted into the hole towards the end of the cavity which is located at the opposite ending of the hole. Then the inert gas is injected into the cavity until a desired purity of inert gas is achieved. Finally the object is pulled out and the input which acted as an output at the same time, is closed. A design with one hole which functions both as an inlet and outlet has the advantage that after filling the cavity with inert gas only one hole needs to be sealed.

In a preferred embodiment the desired purity of inert gas in the cavity is at least 99.99%, preferably at least 99,999%. The purer the gas is, the less likely it has reactive components in it which will react with components in the cavity.

It is conceivable that the usage of a high purity inert gas does not always meet the goal of the actual intention due to the high expenses which come along with high purity gas. Preferably, when using an appropriate protective gas, attention must be paid to affordability of the gas and sufficient protection against corrosion.

The invention reaches more visible space for design and communication activities in consumer product packages such as hinge-lid boxes for smoking articles, especially at the inner parts of the packages. Further advantages and embodiments are illustrated in the attached drawings.

Herein show:

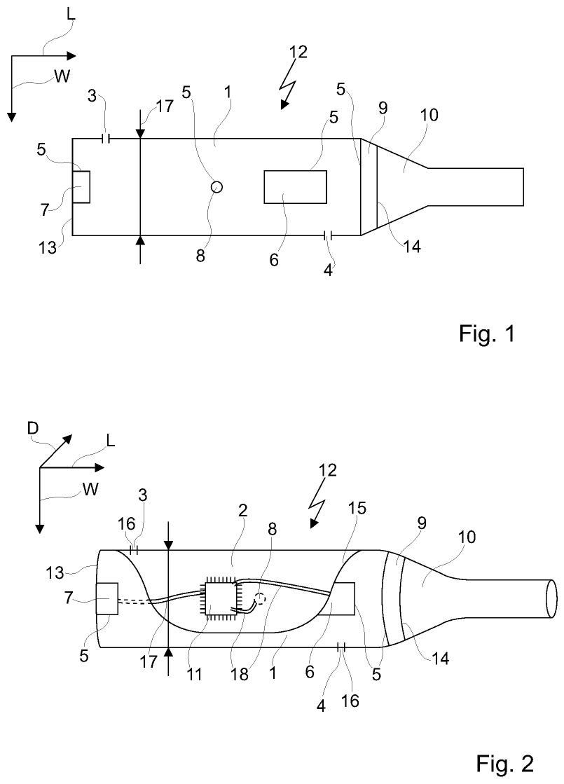

FIG. 1 Electronic smoking device according to the invention

FIG. 2 Electronic smoking device with party sectional view

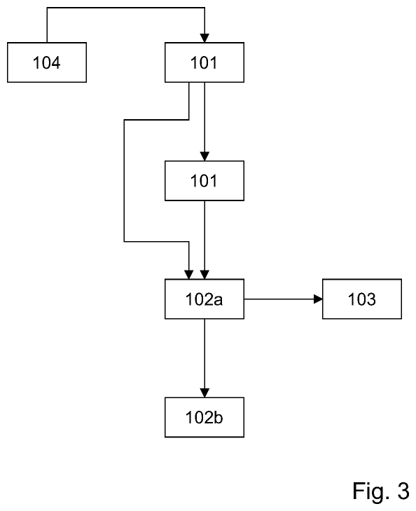

FIG. 3 Organization chart according to the method of the invention

FIG. 1 shows an electronic smoking device 12 according to the invention in a 2D drawing. The electronic smoking device 12 extends in a longitudinal direction L from the bottom part 13 of the device 12 where the data and/or power supply interface 7 is arranged to the upper part 14 of the smoking article where the mouthpiece 10 is attached. The device 12 further extends in a width direction W, wherein the width direction W is perpendicular to the longitudinal direction L and represents the diameter 17 of the electronic smoking device 12. FIG. 1 illustrates the electronic smoking device 12 from the outside. This view shows especially the components which are attached to the outer hull 1 of the device 12. These components may include an input 3, an output 4, a display 6, a data and/or power supply interface 7, a button 8, a receptacle for a mouth piece 9 and the respective sealings 5 of the components. Further a mouth piece is illustrated to ensure a better understanding of the arrangement of the electronic smoking device 12 in FIG. 1.

The input 3 and output 4 in FIG. 1 are illustrated without their respective closure 16 in an open state, wherein in this state they connect the interior of the device 12 with its outside environment. Contrary, in FIG. 2 the input 3 and output 4 are illustrated in a closed state with a respective closure 16 closing these holes. Each hardware component which is attached to the outer hull 1 is provided with at least one seal 5 to the hull 1 to prevent possible holes and air leakage into the cavity 2. The receptacle for the mouth piece 9 has at least two seals 5, because it must be sealed to the outer hull 1 and also to the mouth piece 10.

Preferably all electric parts 11 of the hardware components are arranged inside the cavity 2 and by that enclosed by the outer hull 1. It is conceivable that the hardware components at least partially stand out from the surface of the outer hull 1, especially physical interfaces such as buttons 8 might stand out from the surface of the outer hull 1 to be reachable by a customer. Conversely, it might be advisable to bring USB ports 7 or a display 6 to the same level as the surface of the outer hull 1, or to completely sink them into the cavity 2 inside the device 12, as they might otherwise present obstacles to getting stuck on.

FIG. 2 shows the same electronic smoking device 12 as FIG. 1, but in a partly sectional and also three dimensional view. The orientation of the electronic smoking device 12 in its longitudinal direction L and width direction W is the same as in FIG. 1, wherein it further comprises a depth direction D which is orthogonal to the longitudinal direction L and the width direction W and thereby opens a three dimensional space. Again, a mouth piece 10 is shown for a better understanding of the arrangement of the device 12. Also the receptacle for the mouth piece 9 and respective sealings 5 for all attached components are illustrated. FIG. 2 also illustrates the input 3 and output 4 of the device 12, now in a closed state, wherein they are closed with their respective closures 16. In this state fluids can no longer pass between the outside of the device 12 and the inner cavity 2. The display 6, attached to the outer hull 1 of the device 12, is illustrated, wherein the display 6 is not completely illustrated due to the sectional view in this figure. This view is created by a sectional cut 15 which is arranged to “cut open” a part of the outer hull 1, allowing a view into the inside of the outer hull 1, the inner cavity 2. Due to this cut 15 all parts which are attached to the outer hull 1 below the display 6, according to the longitudinal direction L, are not visible, wherein instead in this area parts, preferably electric parts, which are arranged inside the inner cavity 2 can be seen. This includes in particular the electronic parts 11, as well as data connections inside the device 18. For a better understanding the button 8 which is normally not visible in this representation, is shown as a dashed line. Also the part of the data connection 18, which runs from the electric part 11 to the USB interface 7, in the section where it is normally hidden by the outer hull 1, is shown as a dashed line.

If a hardware component embedded in the outer hull 1 is used as an input and/or output, the input 3 and output 4 and their respective closures 16 would be superfluous and omitted.

To execute the method according to the invention an object which is able to guide a fluid through the input 3 into the cavity 2 is attached to the input 3 which is in this state not closed with a closure 16 (FIG. 1). When applying a vacuum to the cavity 2 an additional pump may be attached to the output 4 to drain the fluid from the cavity 2. In this case due to filling a fluid through the input 3 into the cavity 2, preferably the same amount of fluid is released from the cavity 2 through the output 4. After the filling process is completed, the input 3 and output 4 are closed with a closure 16 as it is shown in FIG. 2. In the case of adding a pump to the filling process, a protective gas would be alternately filled through the input 3 into the cavity 2 and the fluid inside the cavity 2 would be drained.

FIG. 3 shows an organization chart of the method according to the invention. The first step is filling inert gas into the cavity 100, wherein this step leads to the second step which is displacing the fluids inside the cavity by flushing them out 101. Due to the fact that the displacement of fluids inside the cavity by flushing them out 101 is related to the filling of inert gas into the cavity 100, step 100 can be executed as long as necessary to flush all undesirable fluids out of the cavity 101. This means, that Steps 100 and 101 do not start at the same time, but they end at the same time. After achieving a desired purity of inert gas inside the cavity, the cavity is closed 102a, wherein this leads to two options. Either the cavity is closed with a specially designed closure which would be step 102b, or hardware of the electronic smoking device closes the cavity which would be step 103. There is one more way to vary the sequence, wherein the first step 100 is applied after applying a vacuum to the cavity 104. Steps 100 and 104 can be repeated alternately as often as wanted to achieve a desired purity inside the cavity. If the desired purity inside the cavity is achieved by step 100 and 104, step 101 may be skipped.

### REFERENCE SIGNS

1 outer hull of electronic smoking device
2 inner cavity of electronic smoking device
3 input
4 output
5 fluid tight sealing
6 display
7 data and/or power supply interface
8 button
9 receptacle for mouth piece
10 mouth piece
11 electronic part inside the cavity
12 electronic smoking device
13 bottom part of electronic smoking device
14 upper part of electronic smoking device
15 sectional cuts
16 closures
17 diameter of electronic smoking device
18 data connection inside the device
100 filling inert gas into the cavity
101 displacing fluids inside the cavity by flushing them out
102 closing the cavity with a closure
103 hardware of electronic smoking device closes the cavity
104 applying vacuum to the cavity before filling with inert gas
L longitudinal direction
W width direction
D depth direction

1. A method for excluding humidity and/or oxygen and/or other fluids from an inner cavity of an electronic smoking device surrounded by an outer hull, the cavity being fluid tight to environment by at least one seal and having at least one input and at least one output comprising at least one hole through the hull and into the cavity through which fluids can pass and which can be closed with a closure, wherein,
filling an inert gas through the input into the cavity; displacing fluids inside the cavity by flushing the fluids out with the inert gas through the output; and
permanently closing the input and the output with respective closures.

2. The method according to claim 1,
wherein,
the input and/or the output are valves, or are each a hole in the hull for a later attached hardware, wherein the hardware closes the hole when attached to the hole and thereby acts as the closure, wherein the hardware is a USB-port and/or a display.

3. The method according to claim 1, further comprising:
before filling the cavity with the inert gas and closing the input and output, applying a vacuum to the cavity.

4. The method according to claim 3, further comprising:
repeating the procedure of applying vacuum to the cavity and then filling the cavity with an inert gas at least once before the input and output is closed.

5. The method according to claim 1,
wherein,
the inert gas is nitrogen and/or a noble gas.

6. The method according to claim 1,
wherein,
a filling pressure of the inert gas into the cavity is 2 psi.

7. An electronic smoking device with an inner cavity surrounded by an outer hull, the cavity being fluid tight to its environment by at least one seal and having at least one input and one output comprising at least one hole through the hull and into the cavity through which fluids can pass and which can be closed with a respective closure,
wherein,
the inner cavity comprises an inert gas, wherein the inert gas prevents the risk of corrosion, fogging, moisture building and high pressure building.

8. The electronic smoking device according to claim 7,
wherein,
the input and output are located at positions in the hull, which comprise a respective maximum distance to each other.

9. The electronic smoking device according to claim 7,
wherein,
the closure of the input and/or output is a valve, USB plug and/or other component, which is inserted in the hull.

10. The electronic smoking device according to claim 7,
wherein,
the seal for the input and output is fluid tight.

11. The electronic smoking device according to claim 7,
wherein,
the cavity encloses electronic parts.

12. The electronic smoking device according to claim 7,
wherein,
the pressure inside the cavity is set to a minimum value of 2 psi overpressure.

13. The electronic smoking device according to claim 7,
wherein,
the input and output are arranged in the same hole in the hull.

14. The electronic smoking device according to claim 7,
wherein,
a purity of the inert gas in the cavity is at least 99.99%.

15. The electronic smoking device according to claim 14, wherein the purity of the inert gas in the cavity is at least 99.999%.

16. The method according to claim 2, wherein the input and the output are one-way valves.
